(19) United States
(12) Patent Application Publication
(10) Pub. No.: US 2018/0357363 A1
(43) Pub. Date: Dec. 13, 2018

(54) PROTEIN DESIGN METHOD AND SYSTEM

(71) Applicant: OFEK - ESHKOLOT RESEARCH AND DEVELOPMENT LTD, Karmiel (IL)

(72) Inventor: Zakharia FRENKEL, Haifa (IL)

(21) Appl. No.: 15/775,305

(22) PCT Filed: Nov. 10, 2016
(86) PCT No.: PCT/IL2016/051216

§ 371 Date: May 10, 2018

Related U.S. Application Data
(60) Provisional application No. 62/253,153, filed on Nov. 10, 2015.

(51) Int. Cl. G06F 19/18; G06F 19/24; G06F 19/26

(52) U.S. Cl. CPC G06F 19/18; G06F 19/26; G06F 19/24

(57) ABSTRACT

A method for annotating a protein sequence or a subsequence thereof includes the steps of providing an input protein sequence or a subsequence thereof. The subsequence is defined as a central node of a graph or protein network. A subgraph of the graph is calculated including the central node, according to a predefined radius and weights and/or resistances of edges of the subgraph are also calculated. Annotated nodes in the subgraph are identified. Resistance values between the central nodes and each of the annotated nodes in the subgraph are calculated and a list of annotated nodes is outputted. Each of the annotated nodes has a characteristic calculated resistance value to the central node of the input protein sequence.

### FIELD OF THE INVENTION

The subject matter relates generally to protein design via protein networks and more specifically to a system and method for characterizing functional and/or structural protein modules via protein network.

### BACKGROUND OF THE INVENTION

To establish possible function of a newly discovered protein, alignment of its sequence with other known sequences is required. When the similarity is marginal, the function remains uncertain.

Annotation of protein sequences requires pair-wise or multiple sequence alignment (Trifonov E. N. & Frenkel Z. M. Evolution of protein modularity. Current Opinion in Structural Biology, 2009; 19, 1-6). When the compared sequences share a high level of identity, the alignment does not pose any problems. The task becomes trouble-some in the case of low identity between the sequences and if several gaps (or, more exactly, indels) are present.

A commonly used approach in such cases is introduction of specific weights (or ‘costs’) for mismatches (substitution matrix) and indels, and search for optimal ‘configuration’, which corresponds to the maximal score. Typically, some statistically evaluated optimal solution is offered. Indeed, every structurally/functionally specific site in the protein should allow only certain correlated types of mutations, which are leveled down when one general substitution matrix is used. Several modifications of the standard method, such as Position-Specific Iterated BLAST (PSI-BLAST) or Compositionally Adjusted Substitution Matrices do improve the alignment, but do not solve the problem.

The Intermediate Sequence Search (ISS) technique was successfully applied for detecting marginally similar pairs of proteins (Park J., Teichmann, S. A., Hubbard, T. & Chothia, C. Intermediate sequences increase the detection of homology between sequences. Journal of Molecular Biology, 1997; 273, 349-354). The ISS approach “links” proteins that do not show significant sequence similarity between them, but are both detectably related to a third protein—intermediate sequence. However, this approach is limited since it is also based on sequence comparison between proteins.

U.S. Pat. No. 8,849,575 teaches methods of identifying bio-molecules with desired properties, from complex bio-molecule libraries or sets of such libraries. In this patent, parental sequences are aligned to determine which residues vary between parental sequences, then an evolutionary substitution matrix is applied to identify a subset of the variable residues that represent conservative substitutions. A protein variant library is then generated that incorporates the conservative subset of variable amino acid residues into the sequences of the protein variants.

U.S. Pat. No. 6,792,355 teaches an apparatus and method to separating two or more subsets of polypeptides within a set of polypeptides. The method disclosed in this patent uses amino acid sequence pairwise comparison scores (Smith-Waterman, BLAST, FASTA, Needleman-Wunach, Seller and PSI-BLAST) for identifying a sequence comparison signature.

US patent application 2013090266 discloses a method for improved peptide screening library design methods utilize screening data relating to a plurality of peptides used in a peptide screen against a target molecule to construct a consensus binding sequence alignment using least a subset of the plurality of peptides.

The art described above is directed towards systems and methods of searching sequence space data using pattern or consensus or motif recognition sequences.

In view of the above there is still a long felt and unmet need for effectively characterizing functional and/or structural modules of a protein.

### SUMMARY OF THE INVENTION

These needs and other unstated objectives are solved by the techniques of the invention which are described hereinbelow.

In one exemplary embodiment of the invention a method for annotating a protein sequence or a subsequence thereof, comprises the steps of:
a. providing an input protein sequence or a subsequence thereof;
b. defining said subsequence as a central node of a graph or protein network;
c. calculating a subgraph of said graph comprising said central node, according to a predefined radius;
d. calculating weights and/or resistances of edges of said subgraph;
e. identifying annotated nodes in said subgraph;
f. calculating resistance values between said central nodes and each of said annotated nodes in said subgraph; and
g. outputting a list of annotated nodes, wherein each of said annotated nodes is characterized by said calculated resistance value to said central node of said input protein sequence.

In another exemplary embodiment of the invention, a method for annotating a protein sequence or a subsequence thereof, comprises the steps of:
a. providing an input protein sequence or a subsequence thereof comprising about 15 to about 25 amino acids;
b. defining said subsequence as a central node of a graph or protein network;
c. calculating a subgraph of said graph comprising said central node, according to a predefined radius;
d. calculating weights and/or resistances of edges of said subgraph;
e. optionally, adding fake edge(s) to said subgraph;
f. identifying annotated nodes in said subgraph;
g. calculating resistance values between said central nodes and each of said annotated nodes in said subgraph; and
h. outputting a list of annotated nodes, wherein each of said annotated nodes is characterized by said calculated resistance value to said central node of said input protein sequence.

Still another exemplary embodiment of the present techniques includes a method for annotating a protein sequence or a part thereof, comprising the steps of:
a. providing an input protein sequence or a part thereof;
b. dividing said protein sequence or a part thereof into subsequences of about 15 to about 25 amino acids;
c. defining each of said subsequences as a central node of a graph or protein network;
d. calculating or extracting a subgraph of said graph for each of said central nodes, according to a predefined radius;
e. calculating weights and/or resistances of edges of each of said subgraphs;
f. optionally, adding fake edge(s) to at least one of said subgraphs;
g. identifying annotated nodes in each of said subgraphs;
h. calculating resistance values between said central nodes and each of said annotated nodes in each of said subgraphs; and
i. outputting a list of annotated nodes, wherein each of said annotated nodes is characterized by said calculated resistance value to said central node of said input protein sequence or a part thereof.

Yet another exemplary embodiment of the present inventive techniques discloses a method for characterizing functional and/or structural modules of a protein, comprising the steps of:
a. providing an input protein sequence or a part thereof;
b. dividing said input protein into subsequences, each of said subsequences is corresponding to a position of said input protein;
c. defining each of said subsequences as a central node of a graph;
d. for each of said central nodes, extracting or calculating a subgraph of said graph according to a predefined radius;
e. calculating weights and/or resistances of edges for each of said subgraphs;
f. clustering each of said subgraphs according to said calculated weights and/or resistances, alternatively, selecting nodes with minimal resistance to said central node for each of said subgraphs;
g. for each of said subgraphs corresponding to each of said positions of said input protein, generating a list of protein content of each of the clusters containing each of said central nodes, said protein content list comprising at least one of the following (1) names of proteins containing subsequences or nodes forming each of said clusters, (2) independent annotations of subsequences or nodes of each of said clusters;
h. comparing between the protein content list of clusters containing central nodes corresponding to neighboring or adjacent positions of said input protein;
i. identifying positions in said input protein with similar protein content, according to a predefined threshold;
j. mapping the functional and/or structural modules of said input protein by connecting said positions of similar protein content clusters, thereby defining a functional or structural module of said input protein.

The previous exemplary embodiment may further comprise the steps of clustering said subgraphs by a function or algorithm selected from the group consisting of spectral algorithm, Markov algorithm, genetic algorithm, simulating annealing and any other method or approach reviewed in at least one of the following: (1) E. Schaeffer, “Graph clustering,” Computer Science Review, vol. 1, pp. 27-64, 2007, (2) S. Fortunato, “Community detection in graphs,” Physics Reports-Review Section of Physics Letters, vol. 486, pp. 75-174, February 2010], clustering according to calculated distances between the nodes by PAM algorithm, hierarchical clustering, other data clustering algorithms and any combination thereof. Alternatively or additionally, it may further comprise the steps of comparing between said protein contents by a calculation method or approach selected from the group consisting of Jaccard index, Jaccard similarity coefficient, finding of the most frequent annotation, mutual information and any combination thereof. Additionally or alternatively, the previous method may further comprise the step of creating a publicly available expandable database of said modules.

Still another exemplary embodiment of the present techniques discloses methods for global characterization of proteins, particularly for protein function annotation, comprising the steps of:
a. providing an input protein sequence or a part thereof;
b. dividing said input protein into subsequences;
c. defining each of said subsequences as a central node of a protein graph;
d. for each of said central nodes, extracting or calculating a subgraph of said graph according to a predefined radius;
e. calculating weights and/or resistances of edges connecting the nodes within each of said subgraphs;
f. optionally, adding fake edge(s) to at least one of said subgraphs;
g. identifying and selecting proteins containing more than one node connected to different subgraphs; if such proteins are absent or they are not annotated, identifying similarly annotated proteins in different subgraphs;
h. estimating strength of said connections by calculating resistances between said nodes to said central nodes, wherein the higher resistance value the lower strength of said connections; optionally, defining a threshold for connection strength below which said connection will be regarded as insignificant;
i. outputting a descending list of proteins, generated according to size of homology region between said node and said input protein; and
j. annotating or defining said function of said input protein according to the top proteins of said descending list, alternatively, protein function can be annotated or defined as a list of annotations of modules of the protein, produced as described in claim 3.

The preceding method may further comprise the steps of calculating the homology region by an algorithm determining that, for a node size of about 20 amino acids, if two remote nodes of a selected protein are found to be connected to two different subgraphs derived from remote nodes or subsequences of said input protein, then the homology region is defined as about 40 amino acids, if the nodes of the selected protein are found to be connected to two adjacent positions of said input protein, the homology region is defined as having about 21 amino acids.

In still a further exemplary embodiment of the present inventive techniques, there is disclosed a method for protein sequence alignment comprising the steps of:
a. providing two input protein sequences for alignment;
b. dividing said input protein sequences into subsequences;
c. defining each of said subsequences of one of said input protein sequences, as a central node of a graph;
d. for each of said central nodes, extracting or calculating a subgraph of said graph according to a predefined radius;
e. calculating weights and/or resistances of edges for each of said subgraphs;
f. selecting pairs of nodes comprising said central node, and the closest node or subsequence from the second input protein to said central node of each subgraph;
g. generating an alignment map according to said pairs of nodes and according to their corresponding resistances; and
h. optionally, generating a multiple alignment map by repeating steps a to g for one or more additional input protein sequences.

Additionally disclosed are exemplary embodiments of a method for associating a set of local patterns or profiles recognition with a protein function, comprising the steps of:
a. providing an input protein sequence or a part thereof;
b. dividing said input protein into subsequences;
c. defining each of said subsequences as a central node of a graph;
d. for each of said central nodes, extracting or calculating a subgraph of said graph according to a predefined radius;
e. calculating weights and/or resistances of edges for each of said subgraphs;
f. clustering said subgraphs and/or identifying paths through said subgraphs, according to said calculated weights and/or resistances;
g. calculating patterns and /or profiles according to said clusters and/or paths of step f; and
h. associating said patterns and/or profiles with protein function available from annotated nodes or subsequences of correspondent clusters or paths.

An additional method for protein interaction prediction comprises the steps of:
a. providing an input protein sequence or a part thereof;
b. dividing said input protein into subsequences;
c. defining each of said subsequences as a central node of a graph;
d. for each of said central nodes, extracting or calculating a subgraph of said graph according to a predefined radius;
e. calculating weights and/or resistances of the edges for each of said subgraphs;
f. clustering said subgraphs and/or identifying paths through said subgraphs, according to said calculated weights and/or resistances;
g. correlating between mutations according to said clusters and/or paths of step f; and
h. predicting protein interactions according to the results of step g.

### BRIEF DESCRIPTION OF THE DRAWINGS

Exemplary non-limiting embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 is schematically illustrating a flow chart of a method for annotating a protein sequence or a subsequence thereof, according to exemplary embodiments of the subject matter; and

FIG. 2 is schematically illustrating a flow chart of a method for generating a weighted relatedness protein network, according to some exemplary embodiments of the subject matter.

### DETAILED DESCRIPTION OF PREFFERED EMBODIMENTS OF THE INVENTION

The biological functions of proteins are uniquely defined by their amino acid sequence.

But exactly how this correspondence is established remains a problem of protein sequence analysis to be solved.

The present invention is directed towards the determination of properties, for example, 3D structure, the biological role and mechanism of functioning, of any protein of interest.

The present invention is directed towards development and implementation of a novel approach for functional and/or structural protein annotation, via Protein Connectivity Network in sequence space (PCN).

Among its objectives, the present invention is designed and adapted for common use by pre-calculations and storage of huge amounts of sequence comparison data as well as development of advanced algorithms for analysis of ultra large network graphs. Accordingly, the present disclosure solves these computational problems by application of network clustering algorithms together with physical modeling, for example by considering the graph as a system of water-flow tubes and/or as an electrical conducting network.

Without wishing to be bound by theory, the present invention is based on the assumption that most of the proteins are composed of evolutionarily conserved modules of standard size of about 25-30 amino-acid residues. Typically, these modules appear as closed loops.

It is further submitted that the sequences of the protein modules are highly variable while their functions and structures are rather conserved. This sequence diversity of the modules accumulated during the evolutionary process and has been a major obstacle to the reliable detection of such modules through sequence analysis. A solution for this problem is proposed by the present invention: the relatedness of the variable sequences is represented by networks in natural protein sequence space.

The present invention, surprisingly, detects homology between small conserved protein modules or fragments, and moreover, predicts their function, as opposed to that of full protein which was done by the initial Intermediate Sequence Search (ISS) approach, which opened a new era in sequence analysis.

It is demonstrated by the novel approach of the present invention that small protein segments (about 20 aa) can form longer ‘walks’ or ‘paths’ in a protein sequence space. The ‘walk’ is herein defined as a chain of sequence fragments, where each element of the path (i.e. sequence fragment) has high similarity to its neighbors. A combination of ‘walks’ forms a network. Note that the fragments are not physically connected to one another, only connected by their similarity exceeding some threshold.

Contrary to random sequence spaces of the same size, the sequence walks in natural space are significantly longer. It is unexpectedly shown that in many instances the 3D-structure and function of the initial fragment is conserved through the walk, despite sequence changes.

It should be emphasized, that while there are examples in the prior art considering the construction of different protein networks, they were apparently unaware of the utility of an optimal sequence size for constructing the network, making their approaches inapplicable for detection of hidden homology.

The presently disclosed subject matter provides means and methods for generating and analyzing a network of protein sequences represented via electronic models or properties. The protein network is generated according to similarities between various protein sequences that are represented in the network. The network of the subject matter provides reliable annotation for many cases in which all other existing methods are inefficient and thus opens new possibilities of protein clustering and design. The protein network enables better prediction of protein properties, as elaborated below

A further aspect of the present invention is to generate an improved protein network or in other words to improve the prediction power of preexisting protein networks. This is achieved by adding to a given protein connectivity network (hereinsfter “PCN”), additional nodes (i.e. protein fragments) derived from annotated protein sequence database, such as ASTRAL database (which comprises proteins with known structure) or SWISS-PROT database (which comprises proteins with known functions). This step is especially important when the given PCN comprises only a limited group of proteins and therefore its predictive power is also limited.

As used herein the term “about” denotes ±25% of the defined amount or measure or value.

The term “protein network” also defined as “protein connectivity network” or “PCN” generally refers to a plurality of protein sequences represented by nodes. A node in the network represents a protein sequence or a fragment or subsequence thereof. A node in the network may be bound by edges to one or more other protein sequences represented by nodes in the network. It is contemplated that the network approach of the present invention is designed to determine either the role of a specific amino acid sequence or protein and/or its relatedness to other proteins with respect to its structure, function or annotation. The disclosed techniques for the use of networks may simplify complex systems by splitting a system into a series of links In the context of protein research, links represent the neighboring protein sequences or nodes that may be connected by edges.

As used herein, the terms “node” or “sequence fragment” or “protein fragment” or “sub-sequence” or “protein sequence or a part thereof” refer hereinafter to a protein sequence or a part thereof comprising about 15 to 25 amino acids, particularly about 20 amino acids. The term node also may refer to the term vertex.

“Graph” as used herein is generally defined as vertices or nodes or points and edges or arcs or lines that connect them. It is herein acknowledged that a graph is an ordered pair G=(V, E) comprising a set V of vertices or nodes or points together with a set E of edges or arcs or lines, which are 2-element subsets of V (i.e., an edge is related with two vertices, and the relation is represented as an unordered pair of the vertices with respect to the particular edge).

In the context of the present invention, a graph is referred to as a complex network. More specifically it refers to a network with non-trivial topological features, with patterns of connection between their elements that are neither purely regular nor purely random. Such features may include, in a non-limiting manner, a heavy tail in the degree distribution, a high clustering coefficient, assortativity or disassortativity among vertices or nodes, community structure, hierarchical structure, reciprocity, triad significance profile and other features. Non limiting examples of complex networks include computer networks, social networks, biological networks, technological networks, electrical networks and more. It is further within the scope that networks can be represented as graphs, which include a wide variety of subgraphs.

“Subgraph” or “sub-graph”, for example where subgraph H, of a graph G, is defined as a graph whose vertices are a subset of the vertex set of G, and whose edges are a subset of the edge set of G. In other words, a graph, G, contains a graph, H, if H is a subgraph of, or is isomorphic to G. In some embodiments, a subgraph, H, spans a graph, G, and is a spanning subgraph, or factor of G, if it has the same vertex set as G.

In some embodiments of the present invention, when relating to steps of ‘extracting or calculating a subgraph’, it encompasses one of the following approaches or possibilities: a) extraction of a subgraph from a pre-calculated or preexisting graph or PCN or database; and b) calculation of the sub-graph “from the beginning”, for example, by iterative comparison of protein fragments or subsequences one to another.

“Distance”, i.e. dG(u, v) between two (not necessarily distinct) vertices u and v in a graph G, refers to the length of a shortest path (also called a graph geodesic) between them. When u and v are identical, their distance is 0. When u and v are unreachable from each other, their distance is defined to be infinity (∞).

“Central node” as used herein refers to the initial node when building a subgraph (i.e. a node from an input protein selected for analysis). In the context of building a subgraph with radius n, the following steps may be applied:

a. providing or selecting a node to be used as a central node in a graph;

b. identifying neighbor nodes to said central node in said graph;

c. identifying neighbor nodes to said neighbor nodes;

d. repeating step c n-times

“Annotated node” as used herein refers to a node in a graph or subgraph with available annotation information. Such information is illustrated, for example in the UniProt site, e.g. http://www.uniprot.org/uniprot/P28749 (Family & Domains).

“Similarly annotated nodes” or “similarly annotated proteins” as used herein generally refers to proteins with at least partial similar available characterization or information or key words, suggesting, these protein have corresponding fragments or at least subsequences with similar function and/or structure. Non limiting examples of such available characterization or information or key words include terms such as “dehydrogenase”, “phosphatase”, “p-loop”, etc.

“Connectivity” as used herein refers to adjacency, it may essentially be a form (and measure) of concatenated adjacency. According to some aspects, if it is possible to establish a path from any vertex to any other vertex of a graph, the graph is said to be connected; otherwise, the graph is disconnected. The vertex connectivity or connectivity κ(G) of a graph G is the minimum number of vertices that need to be removed to disconnect G. The complete graph Kn has connectivity n-1 for n>1; and a disconnected graph has connectivity 0. The edge connectivity κ′(G) of a graph G is the minimum number of edges needed to disconnect G. It is within the scope that a component may be defined as a maximally connected subgraph.

“Network motif” refers hereinafter to a local property of networks, which is defined as recurrent and statistically significant sub-graph or pattern. Network motifs are sub-graphs that repeat themselves in a specific network or even among various networks. Each of the sub-graphs, defined by a particular pattern of interactions between vertices or nodes, may reflect a framework in which particular functions are achieved efficiently. It is further within the scope that motifs may be of notable importance mainly because they may reflect functional properties. In the context of the present invention, they are used to uncover or identify or characterize structural or functional design principles of complex protein networks.

According to further aspects of the present invention, motif discovery algorithms are provided. Such algorithms can be classified under various paradigms such as exact counting methods, sampling methods, pattern growth methods and so on. According to some embodiments, motif discovery comprises two main steps: calculating the number of occurrences of a sub-graph and evaluating the sub-graph significance. In certain aspects, the recurrence is significant if it is detectably far more than expected. The expected number of appearances of a sub-graph can be determined by a Null-model, which is defined by an ensemble of random networks with some of the same properties as the original network.

“Local pattern” as used herein refers to a motif that commonly appears in a group of proteins. There are various kinds of protein motifs. For example, a sequential pattern that repeatedly appears in the nucleotide and/or amino acid sequence is called a sequence motif; a structural pattern that appears in the structure feature is called a structural motif. Such motifs when extracted from proteins with the same function often correspond to functional or binding sites. A binding site which usually forms a concavity is called a pocket, which may be regarded as structural motif candidate.

“Pattern recognition” or “profile recognition” as used herein is concerned with the development of systems that learn to solve a given problem (machine learning) using a set of example instances, each represented by a number of features. Such problems include clustering, the grouping of similar instances, classification, the task of assigning a discrete label to a given instance; and dimensionality reduction, combining or selecting features to arrive at a more useful representation. It is herein acknowledged that statistical pattern recognition algorithms are used in the present invention. Classification and clustering used in the methods of the present invention may be applied to high-throughput measurement data arising from microarray, mass spectrometry and next-generation sequencing experiments for selecting markers, predicting phenotype and grouping objects or genes. The methods of the present invention, which, for example use classification and pattern or profile recognition may be the core of a wide range of tools such as predictors of genes, protein function, functional or genetic interactions, etc., and used extensively in systems biology.

“Cluster” or “clustering” as used herein generally refers to finding natural groupings of items. In the context of the present invention, the term refers to sets of “related” vertices in graphs. It is further within the scope that in graph clustering, each vertex or node is connected to others by weighted or unweighted edges. It is noted that the various measures of cluster quality and algorithms for producing a clustering for a vertex set of an input graph, are included within the scope of the present invention.

According to a further aspect of the present invention, a ‘clustering coefficient’ is defined as a measure of the degree to which nodes in a graph tend to cluster together.

“Reduce redundancy” refers hereinafter to the reduction of duplicated design decisions in user interface complexity when a single feature or hypertext link is presented in multiple ways. In the context of the present invention, the term refers to the reduction of repeats in the training data. Such repeats may cause inaccuracy in the calculation of the average or expected values.

“Root-mean-square deviation (RMSD)” refers hereinafter to the measure of the average distance between the atoms (usually the backbone atoms) of superimposed proteins. In the study of globular protein conformations, one customarily measures the similarity in three-dimensional structure by the RMSD of the Ca atomic coordinates after optimal rigid body superposition.

“Hamming distance” refers hereinafter to the number of positions between two strings of equal length at which the corresponding symbols are different. In other words, it measures the minimum number of substitutions required to change one string into the other, or the minimum number of errors that could have transformed one string into the other. In the context of the present invention the term string refers to a protein sequence or protein fragment, preferably comprising about 20 amino acids and the terms position or symbol refers to a single amino acid within the protein fragment or sequence.

“Objective function” as used herein refers variously also to a loss function or cost function (minimization), a utility function or fitness function (maximization), and generally means a function that maps an event or values of one or more variables onto a number. In some embodiments, an objective function formalizes an optimization problem for which an optimal solution is to be found. In statistics, typically a loss function is used for parameter estimation, and the event in question is a function of the difference between estimated and true values for an instance of data.

“Multiple alignment” or “multiple sequence alignment” or “MSA” as used herein, generally refer to the alignment of three or more biological sequences (protein/amino acid or nucleic acid) preferably of similar length. From the output, homology can be inferred and the evolutionary relationships between the sequences can be studied.

“Protein sequence space” refers hereinafter to a representation of all possible sequences or sequences existing in nature for a protein. It is herein acknowledged that the sequence space has one dimension per amino acid in the sequence leading to highly dimensional spaces. In such a sequence space each protein sequence is adjacent to all other sequences that can be produced through a single mutation. It should be noted that despite the diversity of protein superfamilies, the common protein sequence space is extremely sparsely populated by functional proteins. Most random protein sequences have no fold or function. Enzyme superfamilies, therefore, exist as tiny clusters of active proteins in a vast empty space of non-functional sequences.

“Formatted protein sequence space” means here that all considered sequences are of the same size (preferably comprising about 20 amino acids for our case).

The present invention provides a network in formatted protein sequence space, which is herein defined as protein connectivity network (PCN). The PCN is constructed by nodes, which comprises 20 amino acid fragments, and edges, which are reflecting a relatively low hamming distance between corresponding fragments. A small hamming distance is herein defined as having a sequence identity which is above a predetermined threshold, such as high sequence identity of about 60% and more.

According to one aspect, the most important property of the herein disclosed network is the existence of long ‘paths’ or ‘walks’ in which protein sequences gradually change from one to completely different one, while conserving the structural and functional properties of the corresponding protein fragments.

“Path” or “walk” is herein defined as a chain of sequence fragments, where each element of the path (i.e. sequence fragment) has high similarity to its neighbors. It is further within the scope that a combination of walks forms a network. According to further aspects, a walk or a chain is a sequence of alternating vertices or nodes and edges, beginning and ending with vertices, where each edge's endpoints are the preceding and following vertices in the sequence. A walk is closed if its first and last vertices are the same, and open if they are different. The length l of a walk is the number of edges that it uses. For an open walk, l=n-1, where n is the number of vertices visited (a vertex is counted each time it is visited). For a closed walk, 1=n (the start/end vertex is listed twice, but is not counted twice).

It is further contemplated by the disclosed techniques that a trail is a walk in which all the edges are distinct. A closed trail is sometimes called a tour or circuit.

“Edge” is defined hereinafter as sufficiently high sequence-wise similarity between the protein fragments of corresponding nodes to satisfy a predefined threshold. According to a specific embodiment, an edge is defined as amino acid sequence similarity of 60% or more.

“Fake edge” refers herein after to cases, when annotations of different not-neighboring nodes are similar and thus fake edges between such nodes are added to the network before calculation of the resistances through the network, in order to increase connectivity between the nodes correspondent to protein fragments with potentially similar annotations.

“Relatedness” and “resistance” refer hereinafter to similarity and dissimilarity, respectively, between protein fragments or sequences determined according to predefined weights or properties. In the context of graph theory, the resistance distance between two vertices of a connected graph, G, is equal to the resistance between two equivalent points on an electrical network, constructed so as to correspond to G, with each edge being replaced by a 1 ohm resistance (it is a metric on graphs).

A weighted relatedness or weighted resistance or a weighted graph associates a label (weight) with every edge in the graph. Weights are usually numbers or values. Certain algorithms require further restrictions on weights; for example, Dijkstra's algorithm works properly only for positive weights. The weight of a path or the weight of a tree in a weighted graph is the sum of the weights of the selected edges. In some embodiments, a non-edge (a vertex pair with no connecting edge) is indicated by labeling it with a special weight representing infinity. In some aspects, the term network is a synonym for a weighted graph. A network may be directed or undirected, it may contain special vertices (nodes), such as source or sink.

“Strength” as used herein refers in the context of the present invention to the evaluation of the significance of connections in a graph or network. Connections which are characterized by a resistance value higher than a predetermined threshold are defined as having lower strength or significance, and may not be taken into account or may be ignored or regarded as insignificant.

“Substitution matrix” as used herein refers in the context of bioinformatics and evolutionary biology to the rate at which one character in a sequence changes to other character states over time. Substitution matrices are usually seen in the context of amino acid or DNA sequence alignments, where the similarity between sequences depends on their divergence time and the substitution rates as represented in the matrix.

The similarity value between the nodes corresponding to the protein sequence fragments in the network may be determined according to a hamming distance between two protein sequence fragments. If this value is higher or equal than some selected threshold, for example 60% of identity, the nodes are connected by edge and become neighboring.

According to a further embodiment, relatedness between the protein fragments can be detected via connection between corresponding nodes through the PCN. The probability of two fragments to be similar (independently of their sequences) strongly depends on an amount of alternative paths (flow) and length of these paths.

According to a further embodiment, the present invention uses an electrical model for defining relatedness through the network. This approach takes into account the network parameters, as they directly influence on an electric properties that represents the connectivity through the network. Such properties include conductivity or, oppositely, resistance.

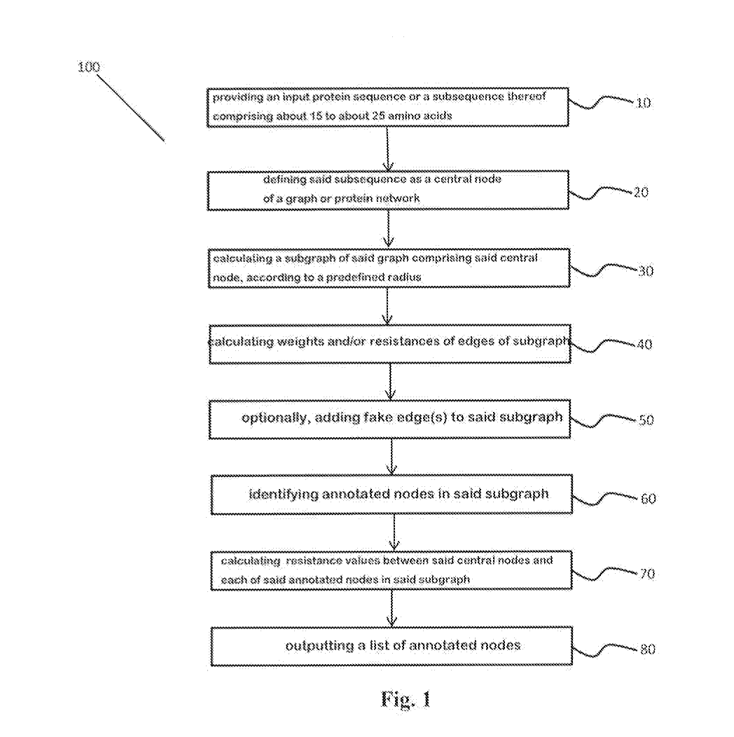

Reference is now made to FIG. 1, presenting an exemplary method for annotating a protein sequence or a subsequence thereof. The aforementioned method comprises steps of:
Step 10 discloses providing an input protein sequence or a subsequence thereof comprising about 15 to about 25 amino acids;
Step 20 discloses defining said subsequence as a central node of a graph or protein network;
Step 30 discloses calculating a subgraph of said graph comprising said central node, according to a predefined radius;
Step 40 discloses calculating weights and/or resistances of edges of said subgraph;
Step 50 discloses optionally, adding fake edge(s) to said subgraph;
Step 60 discloses identifying annotated nodes in said subgraph;
Step 70 discloses calculating resistance values between said central nodes and each of said annotated nodes in said subgraph; and
Step 80 discloses outputting a list of annotated nodes, wherein each of said annotated nodes is characterized by said calculated resistance value to said central node of said input protein sequence.

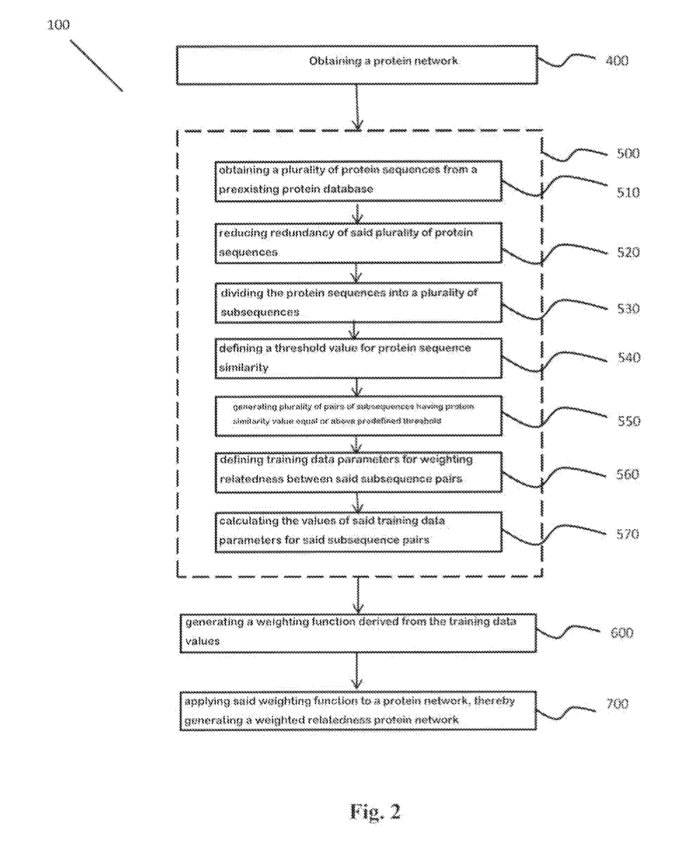

Reference is now made to FIG. 2, presenting an exemplary method for generating a weighted relatedness protein network. The aforementioned method comprises the following steps:
Step 400 discloses obtaining a protein network;
Step 500 discloses generating training data. The training data generation includes the following steps:
Step 510 of obtaining a plurality of protein sequences from a preexisting protein database;
Step 520 discloses reducing redundancy of said plurality of protein sequences;
Step 530 discloses dividing the protein sequences into a plurality of subsequences;
Step 540 of defining a threshold value for protein sequence similarity;
Step 550 of generating a plurality of pairs of said subsequences, said subsequence pairs having a protein similarity value equal or above said predefined threshold;

Step 560 of defining training data parameters for weighting relatedness between said subsequence pairs;
Step 570 discloses calculating the values of said training data parameters for said subsequence pairs;

The aforementioned method further comprises step 600 of generating a weighting function derived from the training data values; and
Step 700 of applying said weighting function to a protein network, thereby generating a weighted relatedness protein network.

Thus, according to one embodiment, the present invention provides a method for generating a weighted relatedness protein network comprising steps of: (a) obtaining a protein network; (b) generating training data; (c) generating a weighting function derived from said training data values; and (d) applying said weighting function to a protein network, thereby generating a weighted relatedness protein network.

According to certain aspects, the step of generating training data comprises steps of; (a) obtaining a plurality of protein sequences from a preexisting protein database; (b) reducing redundancy of said plurality of protein sequences; (c) dividing the protein sequences into a plurality of subsequences; (d) defining a threshold value for protein sequence similarity; (e) generating a plurality of pairs of said subsequences, said subsequence pairs having a protein similarity value equal or above said predefined threshold; (f) defining training data parameters for weighting relatedness between said subsequence pairs; and (g) calculating the values of said training data parameters for said subsequence pairs.

It is further within the scope to provide the method as defined in any of the above, wherein said protein subsequence comprises between about 15 to about 25 amino acids.

It is further within the scope to disclose the method as defined in any of the above, additionally comprising steps of selecting said preexisting protein database from a database classification group consisting of: structural, functional categories, physiological role, gene type, EC scheme, taxonomy of genes, taxonomy of pathways, taxonomy of reactions, taxonomy of ligand/compound, subcellular localization, protein classes, protein complexes, phenotypes, pathways, genetic element type, cellular role, molecular environment, genetic properties, post translational modifications, gene identification list, protein design and mutant stability and affinity prediction (EGAD), cellular roles, metabolic classification, cellular component, process, phylogenetic classification database and any combination thereof.

It is further within the scope to disclose the method as defined in any of the above, additionally comprising steps of selecting said preexisting protein database from a group consisting of protein data bank (PDB), the Research Collaboratory for Structural Bioinformatics (RCSB) PDB, ASTRAL, Database of Macromolecular Movements, Dynameomics, JenaLib, ModBase, OCA, KEGG: Genes, KEGG: Pathways, KEGG: Ligand/Compound, KEGG: Ligand/Enzyme, WIT, OMIM, PDB select, Pfam, PubMed, SCOP, SwissProt, OPM, PDBe, PDB Lite, PDBsum, PDBTM, PDBWiki, ProtCID, Protein, Proteopedia, ProteinLounge, SWISS-MODEL Repository, TOPSAN, UniProt, Swiss-Prot, UniProtKB/Swiss-Prot, ExPASy, PANTHER, BioLiP, STRING, ProFunc, PROTEOME database, database of Clusters of Orthologous Groups of proteins (COG), Enzyme Commission number (EC number) database, GenProtEC, EcoCyc, MIPS: MYGD, MIPS: MATD, PEDANT, Proteome.com: YDP and WormPD, MGI: Mouse Genome Database (MGD), TIGR: Microbial databases TIGR: Expressed Gene Anatomy Database, EGAD, Gene Ontology, Institute Pasteur SubtiList, Institute Pasteur TubercuList, Sanger Centre and any combination thereof.

It is further within the scope to disclose the method as defined in any of the above, additionally comprising steps of selecting said training data parameters for relatedness between said subsequence pairs from a group consisting of: functional similarity, structural similarity, spectral clustering, sequence similarity, solubility, hydrophobicity, electrical conduction, evolutionary ranking and any combination thereof.

It is emphasized that in the described examples the weighted resistances or relatedness is defined as expected structural similarity (or dissimilarity) between protein fragments of correspondent sequences. In those examples the similarity was calculated via root mean square deviation (distance)—RMSD. However, protein relatedness can be defined or calculated by other methods, as described herein below.

It is acknowledged that there is multiplicity of different approaches and tools for quantitative comparison of protein structures (for example, see the publication “Toward more meaningful hierarchical classification of protein three-dimensional structures”, A. May, Prot. Struct. Funct. Genet., (1999) 37, 20-29; and “Comprehensive Evaluation of Protein Structure Alignment Methods: Scoring by Geometric Measures”, R. Kolodny, P. Koehl and M. Levitt; J. Mol. Biol. (2005) 346, 1173-1188, incorporated herein in their entirety). Other definitions of protein relatedness used in the present invention are based on comparison of secondary structure elements, dihedral angles of the protein backbones, methods caring out a procedure similar to sequence alignment for a structural alphabet, calculation of RMSD between subgroups of atoms (minRMS), searching of minimal surface between the virtual backbones, and other conventional methods for calculating protein similarity.

It is according to some aspects of the invention that weighted protein relatedness can be calculated by multiplicity of different approaches and tools for protein functional classification (reviewed in “Comparison of functional annotation schemes for genomes”, S. C. Rison, T. C. Hodgman, & J. M. Thornton, Funct. Integr. Genomics. (2000) 1, 56-69), which is incorporated herein in it's entirety. In other examples, comparison of EC codes of enzymes, KEGG pathway based classification codes, and other conventional protein classifications can be used. It can be also done by comparison of COG codes based on a phylogenetic classification.

In addition, physical characteristics of the protein fragments can be also used, such as solubility, hydrophobicity, electrical conduction and other protein characteristics.

According to a further embodiment, the multiplicity of BLAST-related methods facilitated by position-specific scoring matrix, Hidden Markov Model, recently suggested Markov Random Fields (see, for example, “MRFalign: Protein Homology Detection through Alignment of Markov Random Fields” J. Ma, S. Wang, Z. Wang, J. Xu. (2014). PLoS Comput Biol 10(3):e1003500, which is incorporated herein in it's entirety), can be applied to the sequence comparison.

According to a further embodiment, the amino acid properties (size, polarity, hydrophobicity, charge, H-bonding, and so on) can be taken into account.

According to a further embodiment, the similarity of corresponding genetic DNA sequences can be taken into account.

It is further within the scope to disclose the method as defined in any of the above, additionally comprising steps of smoothing data of said discrete form function via an approximating function selected from a group consisting of: averaging, linear transformation, spline interpolation, monotonic regression, algorithms, density estimator, histogram, smoother matrix, convolution, moving average algorithm, scale space representation, additive smoothing, Butterworth filter, Digital filter, Kalman filter, Kernel smoother, Laplacian smoothing, Stretched grid method, Low-pass filter, Savitzky-Golay smoothing, Local regression, Smoothing spline, Ramer-Douglas-Peucker algorithm, Exponential smoothing, Kolmogorov-Zurbenko filter and any combination thereof.

It is further within the scope to disclose the method as defined in any of the above, wherein each of said plurality of subsequences is represented by a node in the protein network.

It is further within the scope to disclose the method as defined in any of the above, additionally comprises steps of calculating a plurality of distances between said nodes, said distance is calculated according to a protein sequence similarity property.

The present invention provides a method for annotating a protein sequence or a subsequence thereof, comprising steps of:

(a) providing an input protein sequence or a subsequence thereof comprising about 15 to about 25 amino acids;

(b) defining the subsequence as a central node of a graph or protein network;

(c) calculating a subgraph of the graph comprising the central node, according to a predefined radius;

(d) calculating weights and/or resistances of edges of the subgraph;

(e) optionally, adding fake edge(s) to the subgraph;

(f) identifying annotated nodes in the subgraph;

(g) calculating resistance values between the central nodes and each of the annotated nodes in the subgraph; and

(h) outputting a list of annotated nodes, wherein each of the annotated nodes is characterized by the calculated resistance value to the central node of the input protein sequence.

It is further within the scope to disclose a method for annotating a protein sequence or a part thereof, comprising steps of:

(a) providing an input protein sequence or a part thereof;

(b) dividing the protein sequence or a part thereof into subsequences of about 15 to about 25 amino acids;

(c) defining each of the subsequences as a central node of a graph or protein network;

(d) calculating or extracting a subgraph of the graph for each of the central nodes, according to a predefined radius;

(e) calculating weights and/or resistances of edges of each of the subgraphs;

(f) optionally, adding fake edge(s) to at least one of the subgraphs;

(g) identifying annotated nodes in each of the subgraphs;

(h) calculating resistance values between the central nodes and each of the annotated nodes in each of the subgraphs; and

(i) outputting a list of annotated nodes, wherein each of the annotated nodes is characterized by the calculated resistance value to the central node of the input protein sequence or a part thereof.

It is further within the scope to disclose a method for characterizing functional and/or structural modules of a protein, comprising steps of:

(a) providing an input protein sequence or a part thereof;

(b) dividing the input protein into subsequences, each of the subsequences is corresponding to a position of the input protein;

(c) defining each of the subsequences as a central node of a graph;

(d) for each of the central nodes, extracting or calculating a subgraph of the graph according to a predefined radius;

(e) calculating weights and/or resistances of edges for each of the subgraphs;

(f) clustering each of the subgraphs according to the calculated weights and/or resistances, alternatively, selecting nodes with minimal resistance to the central node for each of the subgraphs;

(g) for each of the subgraphs corresponding to each of the positions of the input protein, generating a list of protein content of each of the clusters containing each of the central nodes, the protein content list comprising at least one of the following (1) names of proteins containing subsequences or nodes forming each of the clusters, (2) independent annotations of subsequences or nodes of each of the clusters;

(h) comparing between the protein content list of clusters containing central nodes corresponding to neighboring or adjacent positions of the input protein;

(i) identifying positions in the input protein with similar protein content, according to a predefined threshold; and

(j) mapping the functional and/or structural modules of the input protein by connecting the positions of similar protein content clusters, thereby defining a functional or structural module of the input protein.

It is further within the scope to disclose the method as defined in any of the above, further comprising steps of clustering the subgraphs by a function or algorithm selected from the group consisting of spectral algorithm, Markov algorithm, genetic algorithm, simulating annealing and any other method or approach reviewed in at least one of the following: (1) E. Schaeffer, “Graph clustering,” Computer Science Review, vol. 1, pp. 27-64, 2007, (2) S. Fortunato, “Community detection in graphs,” Physics Reports-Review Section of Physics Letters, vol. 486, pp. 75-174, February 2010], clustering according to calculated distances between the nodes by PAM algorithm, hierarchical clustering, other data clustering algorithms and any combination thereof.

It is further within the scope to disclose the method as defined in any of the above, further comprising steps of comparing between the protein contents by a calculation method or approach selected from the group consisting of Jaccard index, Jaccard similarity coefficient, finding of the most frequent annotation, mutual information and any combination thereof.

It is further within the scope to disclose the method as defined in any of the above, further comprising steps of creating a publicly available expandable database of the modules.

It is further within the scope to disclose a method for global characterization of proteins, particularly for protein function annotation, comprising steps of:

(a) providing an input protein sequence or a part thereof;

(b) dividing the input protein into subsequences;

(c) defining each of the subsequences as a central node of a protein graph;

(d) for each of the central nodes, extracting or calculating a subgraph of the graph according to a predefined radius;

(e) calculating weights and/or resistances of edges connecting the nodes within each of the subgraphs;

(f) optionally, adding fake edge(s) to at least one of the subgraphs;

(g) identifying and selecting proteins containing more than one node connected to different subgraphs; if such proteins are absent or they are not annotated, identifying similarly annotated proteins in different subgraphs;

(h) estimating strength of the connections by calculating resistances between the nodes to the central nodes, wherein the higher resistance value the lower strength of the connections; optionally, defining a threshold for connection strength below which the connection will be regarded as insignificant;

(i) outputting a descending list of proteins, generated according to size of homology region between the node and the input protein; and

(j) annotating or defining the function of the input protein according to the top proteins of the descending list, alternatively, protein function can be annotated or defined as a list of annotations of modules of the protein, produced as described in any of the above.

It is further within the scope to disclose the method as defined in any of the above, further comprising steps of calculating the homology region by an algorithm determining that, for a node size of about 20 amino acids, if two remote nodes of a selected protein are found to be connected to two different subgraphs derived from remote nodes or subsequences of the input protein, then the homology region is defined as about 40 amino acids, if the nodes of the selected protein are found to be connected to two adjacent positions of the input protein, the homology region is defined as having about 21 amino acids.

It is further within the scope to disclose a method for protein sequence alignment comprising steps of:

(a) providing two input protein sequences for alignment;

(b) dividing the input protein sequences into subsequences;

(c) defining each of the subsequences of one of the input protein sequences, as a central node of a graph;

(d) for each of the central nodes, extracting or calculating a subgraph of the graph according to a predefined radius;

(e) calculating weights and/or resistances of edges for each of the subgraphs;

(f) selecting pairs of nodes comprising the central node, and the closest node or subsequence from the second input protein to the central node of each subgraph;

(g) generating an alignment map according to the pairs of nodes and according to their corresponding resistances; and

(h) optionally, generating a multiple alignment map by repeating steps a to g for one or more additional input protein sequences.

It is further within the scope to disclose a method for associating a set of local patterns or profiles recognition with a protein function, comprising steps of:

(a) providing an input protein sequence or a part thereof;

(b) dividing the input protein into subsequences;

(c) defining each of the subsequences as a central node of a graph;

(d) for each of the central nodes, extracting or calculating a subgraph of the graph according to a predefined radius;

(e) calculating weights and/or resistances of edges for each of the subgraphs;

(f) clustering the subgraphs and/or identifying paths through the subgraphs, according to the calculated weights and/or resistances;

(g) calculating patterns and /or profiles according to the clusters and/or paths of step f; and

(h) associating the patterns and/or profiles with protein function available from annotated nodes or subsequences of correspondent clusters or paths.

It is further within the scope to disclose the method as defined in any of the above, wherein steps a to h are used for producing a list of mutational changes corresponding to associated functions.

It is further within the scope to disclose the method as defined in any of the above, wherein steps a to h are used for identifying correlations between protein mutations.

It is further within the scope to disclose the method as defined in any of the above, wherein steps f to h are applied to distinct subgraphs.

It is further within the scope to disclose the method as defined in any of the above, further comprises steps of calculating correlations between mutations of nodes derived from different subgraphs.

It is further within the scope to disclose the method as defined in any of the above, wherein the method is used for producing a list of mutational changes corresponding to their associated functions.

It is further within the scope to disclose a method for protein interaction prediction comprising steps of:

(a) providing an input protein sequence or a part thereof;

(b) dividing the input protein into subsequences;

(c) defining each of the subsequences as a central node of a graph;

(d) for each of the central nodes, extracting or calculating a subgraph of the graph according to a predefined radius;

(e) calculating weights and/or resistances of the edges for each of the subgraphs;

(f) clustering the subgraphs and/or identifying paths through the subgraphs, according to the calculated weights and/or resistances;

(g) correlating between mutations according to the clusters and/or paths of step f; and

(h) predicting protein interactions according to the results of step g.

It is further within the scope to disclose the method as defined in any of the above, wherein the method is used for creating a database selected from the group consisting of: local protein annotation, functional and/or structural modules, protein functional annotation, global protein characterization, protein sequence alignment, functional associated local patterns and/or profile recognition, functional associated mutational changes, mutational correlations, protein interactions and any combination thereof.

It is further within the scope to disclose the use of the method as defined in any of the above for database generation, the database is selected from the group consisting of: local protein annotation, functional and/or structural modules, protein functional annotation, global protein characterization, protein sequence alignment, functional associated local patterns and/or profile recognition, functional associated mutational changes, mutational correlation, protein interaction and any combination thereof.

It is further within the scope to disclose the method as defined in any of the above, wherein the method further comprises steps of visualizing or analysing graph attributes, the graph attributes comprising sequence relatedness, co-existence of several patterns and/or profiles, mutational changes and correlation and any combination thereof.

It is further within the scope to disclose the method as defined in any of the above, wherein the graph visualization or analysis is performed by a format or a tool selected from the group consisting of network analysis software, Pajek, graphvis, Gephi, networkx, Ubigraph, aiSee, Cytoscape, TouchGraph, Tulip, any other format or tool listed in http://www.kdnuggets.com/2015/06/top-30-social-network-analysis-visualization-tools.html (incorporated herein by reference in its entirety) and any combination thereof.

It is further within the scope to disclose the method as defined in any of the above, wherein the method is used for identifying evolutionary connection(s) between protein sequences.

It is further within the scope to disclose the method as defined in any of the above, wherein the method is applied and performed together with bioinformatics tools and methods selected from the group consisting of: all variants of blast, multiple sequence alignment, homology prediction, pattern and/or profile recognition, Hidden Markov Model (HMM), Markov Random Fields (MRFs), any other tool or method listed in https://en.wikipedia.org/wiki/List_of_sequence _alignment_software (incorporated herein by reference in its entirety) and any combination thereof.

It is further within the scope to disclose the method as defined in any of the above, wherein the method further comprises steps of calculating weights and/or resistances using conventional substitution matrices, p-values, different types of objective function, and any combination thereof.

It is further within the scope to disclose the method as defined in any of the above, wherein the method further comprises steps of engineering or designing a protein molecule with desirable properties, the engineering or designing is performed according to the extracted graph attributes comprising correlation between mutations, sequence profiles and patterns local protein annotation, functional annotation, protein interaction, structural and/or functional modules identification and any combination thereof.

It is further within the scope to disclose the method as defined in any of the above, wherein the method further comprises steps of predefining and extrapolating parameters selected from the group consisting of fragment or subsequence size, connectivity or relatedness or resistance threshold, DNA, RNA and amino acid sequence and any combination thereof.

It is further within the scope to disclose the method as defined in any of the above, wherein the method further comprises steps of selecting appropriate subsequence size and a threshold value for connection determination.

It is further within the scope to disclose the method as defined in any of the above, wherein the protein sequence, subsequence, fragment or node comprises between about 15 to about 25 amino acids.

It is further within the scope to disclose the method as defined in any of the above, additionally comprising steps of selecting the graph or database or protein network or PCN from a classification group consisting of: structural, functional categories, physiological role, gene type, EC scheme, taxonomy of genes, taxonomy of pathways, taxonomy of reactions, taxonomy of ligand/compound, subcellular localization, protein classes, protein complexes, phenotypes, pathways, genetic element type, cellular role, molecular environment, genetic properties, post translational modifications, gene identification list, protein design and mutant stability and affinity prediction (EGAD), cellular roles, metabolic classification, cellular component, process, phylogenetic classification database and any combination thereof.

It is further within the scope to disclose the method as defined in any of the above, additionally comprising steps of selecting the graph or database or protein network or PCN from the group consisting of protein data bank (PDB), the Research Collaboratory for Structural Bioinformatics (RCSB) PDB, ASTRAL, Database of Macromolecular Movements, Dynameomics, JenaLib, ModBase, OCA, KEGG: Genes, KEGG: Pathways, KEGG: Ligand/Compound, KEGG: Ligand/Enzyme, WIT, OMIM, PDBselect, Pfam, PubMed, SCOP, SwissProt, OPM, PDBe, PDB Lite, PDBsum, PDBTM, PDBWiki, ProtCID, Protein, Proteopedia, ProteinLounge, SWISS-MODEL Repository, TOPSAN, UniProt, Swiss-Prot, UniProtKB/Swiss-Prot, ExPASy, PANTHER, BioLiP, STRING, ProFunc, PROTEOME database, database of Clusters of Orthologous Groups of proteins (COG), Enzyme Commission number (EC number) database, GenProtEC, EcoCyc, MIPS: MYGD, MIPS: MATD, PEDANT, Proteome.com: YDP and WormPD, MGI: Mouse Genome Database (MGD), TIGR: Microbial databases TIGR: Expressed Gene Anatomy Database, EGAD, Gene Ontology, Institute Pasteur SubtiList, Institute Pasteur TubercuList, Sanger Centre and any combination thereof.

It is further within the scope to disclose the method as defined in any of the above, additionally comprising steps of calculating structural similarity by a measure selected from the group consisting of: root mean square deviation (RMSD), exponent of minus squared dissimilarity divided by squared standard deviation, variance measure, probability distribution function, secondary structure assignment, native contact maps, residue interaction patterns, measures of side chain packing, measures of hydrogen bonds retention, dihedral angles of the protein backbones, minRMS, secondary structure elements (SSEs), TM-score, TM-align, protein 3D structure alignment, Residue physic-chemical properties and any combination thereof.

It is further within the scope to disclose the method as defined in any of the above, additionally comprising steps of calculating similarity of protein sequences by parameters selected from the group consisting of number of mismatches, hamming distance, position of mismatches relative to the subsequence, sequence complexity, number of repeating amino acids, existence of indels, position specific scoring matrix, hidden Markov Model, Markov Random Field, amino acid properties, similarity to corresponding genetic DNA sequences and any combination thereof.

It is further within the scope to disclose the method as defined in any of the above, additionally comprising steps of selecting the amino acid properties from the group consisting of size, polarity, hydrophobicity, charge, H-bonding and any combination thereof.

It is further within the scope to disclose the method as defined in any of the above, additionally comprising steps of calculating protein sequence similarity by a measure selected from the group consisting of: hamming distance, sequence alignment, BLAST, FASTA, SSEARCH, GGSEARCH, GLSEARCH, FASTM/S/F, NCBI BLAST, WU-BLAST, PSI-BLAST and any combination thereof.

Further core aspects of the present invention include providing novel and improved methods for mapping and characterizing functional and structural protein modules, creation of databases of such modules, global characterization of proteins, protein function annotation, protein sequence alignment, identifying local patterns and/or profiles and associating them to a corresponding function, correlating mutations and their corresponding associated function and protein interactions prediction.

The methods mentioned above as inter alia presented are used for various bioinformatics applications such as creation of corresponding databases, finding evolutionary connections and relations between protein sequences and engineering and designing of protein molecules with desirable properties.

The present invention further encompasses any application of the disclosed methods in pharma and protein design fields including drug design (ligand-based drug design and structure-based drug design), protein engineering, drug discovery, biomolecular targets discovery and identification, high-throughput technology for protein structure and function relatedness, enzyme engineering, molecular modeling, design of new functional proteins and development of biosimilar products.
2. A method for annotating a protein sequence or a subsequence thereof, comprising steps of:
   a. providing an input protein sequence or a subsequence thereof comprising about 15 to about 25 amino acids;
   b. defining said subsequence as a central node of a graph or protein network;
   c. calculating a subgraph of said graph comprising said central node, according to a predefined radius;
   d. calculating weights and/or resistances of edges of said subgraph;
   e. optionally, adding fake edge(s) to said subgraph;
   f. identifying annotated nodes in said subgraph;
   g. calculating resistance values between said central nodes and each of said annotated nodes in said subgraph; and
   h. outputting a list of annotated nodes, wherein each of said annotated nodes is characterized by said calculated resistance value to said central node of said input protein sequence.
3. A method for annotating a protein sequence or a part thereof, comprising steps of:
   a. providing an input protein sequence or a part thereof;
   b. dividing said protein sequence or a part thereof into subsequences of about 15 to about 25 amino acids;
   c. defining each of said subsequences as a central node of a graph or protein network;
   d. calculating or extracting a subgraph of said graph for each of said central nodes, according to a predefined radius;
   e. calculating weights and/or resistances of edges of each of said subgraphs;
   f. optionally, adding fake edge(s) to at least one of said subgraphs;
   g. identifying annotated nodes in each of said subgraphs;
   h. calculating resistance values between said central nodes and each of said annotated nodes in each of said subgraphs; and
   i. outputting a list of annotated nodes, wherein each of said annotated nodes is characterized by said calculated resistance value to said central node of said input protein sequence or a part thereof.
4. A method for characterizing functional and/or structural modules of a protein, comprising steps of:
   k. providing an input protein sequence or a part thereof;
   l. dividing said input protein into subsequences, each of said subsequences is corresponding to a position of said input protein;
   m. defining each of said subsequences as a central node of a graph;
   n. for each of said central nodes, extracting or calculating a subgraph of said graph according to a predefined radius;
   o. calculating weights and/or resistances of edges for each of said subgraphs;
   p. clustering each of said subgraphs according to said calculated weights and/or resistances, alternatively, selecting nodes with minimal resistance to said central node for each of said subgraphs;
   q. for each of said subgraphs corresponding to each of said positions of said input protein, generating a list of protein content of each of the clusters containing each of said central nodes, said protein content list comprising at least one of the following (1) names of proteins containing subsequences or nodes forming each of said clusters, (2) independent annotations of subsequences or nodes of each of said clusters;
   r. comparing between the protein content list of clusters containing central nodes corresponding to neighboring or adjacent positions of said input protein;
   s. identifying positions in said input protein with similar protein content, according to a predefined threshold;
   t. mapping the functional and/or structural modules of said input protein by connecting said positions of similar protein content clusters, thereby defining a functional or structural module of said input protein.
5. The method according to claim 3, further comprises steps of clustering said subgraphs by a function or algorithm selected from the group consisting of spectral algorithm, Markov algorithm, genetic algorithm, simulating annealing and any other method or approach reviewed in at least one of the following: (1) E. Schaeffer, “Graph clustering,” Computer Science Review, vol. 1, pp. 27-64, 2007, (2) S. Fortunato, “Community detection in graphs,” Physics Reports-Review Section of Physics Letters, vol. 486, pp. 75-174, February 2010], clustering according to calculated distances between the nodes by PAM algorithm, hierarchical clustering, other data clustering algorithms and any combination thereof.
6. The method according to claim 3, further comprises steps of comparing between said protein contents by a calculation method or approach selected from the group consisting of Jaccard index, Jaccard similarity coefficient, finding of the most frequent annotation, mutual information and any combination thereof.
7. The method according to claim 3, further comprises steps of creating a publicly available expandable database of said modules.
8. A method for global characterization of proteins, particularly for protein function annotation, comprising steps of:
   a. providing an input protein sequence or a part thereof;
   b. dividing said input protein into subsequences;
   c. defining each of said subsequences as a central node of a protein graph;
   d. for each of said central nodes, extracting or calculating a subgraph of said graph according to a predefined radius;
   e. calculating weights and/or resistances of edges connecting the nodes within each of said subgraphs;
   f. optionally, adding fake edge(s) to at least one of said subgraphs;
   g. identifying and selecting proteins containing more than one node connected to different subgraphs; if such proteins are absent or they are not annotated, identifying similarly annotated proteins in different subgraphs;
   h. estimating strength of said connections by calculating resistances between said nodes to said central nodes, wherein the higher resistance value the lower strength of said connections; optionally, defining a threshold for connection strength below which said connection will be regarded as insignificant;
   i. outputting a descending list of proteins, generated according to size of homology region between said node and said input protein; and
   j. annotating or defining said function of said input protein according to the top proteins of said descending list, alternatively, protein function can be annotated or defined as a list of annotations of modules of the protein, produced as described in claim 3.
9. The method according to claim 7, further comprises steps of calculating said homology region by an algorithm determining that, for a node size of about 20 amino acids, if two remote nodes of a selected protein are found to be connected to two different subgraphs derived from remote nodes or subsequences of said input protein, then the homology region is defined as about 40 amino acids, if the nodes of the selected protein are found to be connected to two adjacent positions of said input protein, the homology region is defined as having about 21 amino acids.
10. A method for protein sequence alignment comprising steps of:
   a. providing two input protein sequences for alignment;
   b. dividing said input protein sequences into subsequences;
   c. defining each of said subsequences of one of said input protein sequences, as a central node of a graph;
   d. for each of said central nodes, extracting or calculating a subgraph of said graph according to a predefined radius;
   e. calculating weights and/or resistances of edges for each of said subgraphs;
   f. selecting pairs of nodes comprising said central node, and the closest node or subsequence from the second input protein to said central node of each subgraph;
   g. generating an alignment map according to said pairs of nodes and according to their corresponding resistances; and
   h. optionally, generating a multiple alignment map by repeating steps a to g for one or more additional input protein sequences.
11. A method for associating a set of local patterns or profiles recognition with a protein function, comprising steps of:
   a. providing an input protein sequence or a part thereof;
   b. dividing said input protein into subsequences;
   c. defining each of said subsequences as a central node of a graph;
   d. for each of said central nodes, extracting or calculating a subgraph of said graph according to a predefined radius;
   e. calculating weights and/or resistances of edges for each of said subgraphs;
   f. clustering said subgraphs and/or identifying paths through said subgraphs, according to said calculated weights and/or resistances;
   g. calculating patterns and/or profiles according to said clusters and/or paths of step f; and
   h. associating said patterns and/or profiles with protein function available from annotated nodes or subsequences of correspondent clusters or paths.
12. The method according to claim 10, wherein steps a to h are used for producing a list of mutational changes corresponding to associated functions.
13. The method according to claim 10, wherein steps a to h are used for identifying correlations between protein mutations.
14. The method according to claim 10, wherein steps f to h are applied to distinct subgraphs.
15. The method according to claim 12, further comprises steps of calculating correlations between mutations of nodes derived from different subgraphs.
16. The method according to claim 14, wherein said method is used for producing a list of mutational changes corresponding to their associated functions.
17. A method for protein interaction prediction comprising steps of:
   a. providing an input protein sequence or a part thereof;
   b. dividing said input protein into subsequences;
   c. defining each of said subsequences as a central node of a graph;
   d. for each of said central nodes, extracting or calculating a subgraph of said graph according to a predefined radius;
   e. calculating weights and/or resistances of the edges for each of said subgraphs;
   f. clustering said subgraphs and/or identifying paths through said subgraphs, according to said calculated weights and/or resistances;
   g. correlating between mutations according to said clusters and/or paths of step f; and
   h. predicting protein interactions according to the results of step g.
18. The method according to any one of claims 1 to 16, wherein said method is used for creating a database selected from the group consisting of: local protein annotation, functional and/or structural modules, protein functional annotation, global protein characterization, protein sequence alignment, functional associated local patterns and/or profile recognition, functional associated mutational changes, mutational correlations, protein interactions and any combination thereof.
19. Use of any one of claims 1 to 17 for database generation, said database is selected from the group consisting of: local protein annotation, functional and/or structural modules, protein functional annotation, global protein characterization, protein sequence alignment, functional associated local patterns and/or profile recognition, functional associated mutational changes, mutational correlation, protein interaction and any combination thereof.
20. The method according to any one of claims 1 to 18, wherein said method further comprises steps of visualizing or analysing graph attributes, said graph attributes comprising sequence relatedness, co-existence of several patterns and/or profiles, mutational changes and correlation and any combination thereof.
21. The method according to claim 19, wherein said graph visualization or analysis is performed by a format or a tool selected from the group consisting of network analysis software, Pajek, graphvis, Gephi, networkx, Ubigraph, aiSee, Cytoscape, TouchGraph, Tulip, any other format or tool listed in http://www.kdnuggets.com/2015/06/top-30-social-network-analysis-visualization-tools.html and any combination thereof.
22. The method according to any one of claims 1 to 20, wherein said method is used for identifying evolutionary connection(s) between protein sequences.
23. The method according to any one of claims 1 to 21, wherein said method is applied and performed together with bioinformatics tools and methods selected from the group consisting of: all variants of blast, multiple sequence alignment, homology prediction, pattern and/or profile recognition, Hidden Markov Model (HMM), Markov Random Fields (MRFs), any other tool or method listed in https://en.wikipedia.org/wiki/List_of_sequence_alignment_software and any combination thereof.
24. The method according to any one of claims 1 to 22, wherein said method further comprises steps of calculating weights and/or resistances using conventional substitution matrices, p-values, different types of objective function, and any combination thereof.
25. The method according to any one of claims 1 to 23, wherein said method further comprises steps of engineering or designing a protein molecule with desirable properties, said engineering or designing is performed according to said extracted graph attributes comprising correlation between mutations, sequence profiles and patterns local protein annotation, functional annotation, protein interaction, structural and/or functional modules identification and any combination thereof.
26. The method according to any one of claims 1 to 24, wherein said method further comprises steps of predefining and extrapolating parameters selected from the group consisting of fragment or subsequence size, connectivity or relatedness or resistance threshold, DNA, RNA and amino acid sequence and any combination thereof.
27. The method according to any one of claims 1 to 25, wherein said method further comprises steps of selecting appropriate subsequence size and a threshold value for connection determination.
28. The method according to any one of claims 1 to 26, wherein said protein sequence, subsequence, fragment or node comprises between about 15 to about 25 amino acids.
29. The method according to any one of claims 1 to 26, additionally comprising steps of selecting said graph or database or protein network or PCN from a classification group consisting of: structural, functional categories, physiological role, gene type, EC scheme, taxonomy of genes, taxonomy of pathways, taxonomy of reactions, taxonomy of ligand/compound, subcellular localization, protein classes, protein complexes, phenotypes, pathways, genetic element type, cellular role, molecular environment, genetic properties, post translational modifications, gene identification list, protein design and mutant stability and affinity prediction (EGAD), cellular roles, metabolic classification, cellular component, process, phylogenetic classification database and any combination thereof.
30. The method according to claim 28, additionally comprising steps of selecting said graph or database or protein network or PCN from the group consisting of protein data bank (PDB), the Research Collaboratory for Structural Bioinformatics (RCSB) PDB, ASTRAL, Database of Macromolecular Movements, Dynameomics, JenaLib, ModBase, OCA, KEGG: Genes, KEGG: Pathways, KEGG: Ligand/Compound, KEGG: Ligand/Enzyme, WIT, OMIM, PDBselect, Pfam, PubMed, SCOP, SwissProt, OPM, PDBe, PDB Lite, PDBsum, PDBTM, PDBWiki, ProtCID, Protein, Proteopedia, ProteinLounge, SWISS-MODEL Repository, TOPSAN, UniProt, Swiss-Prot, UniProtKB/Swiss-Prot, ExPASy, PANTHER, BioLiP, STRING, ProFunc, PROTEOME database, database of Clusters of Orthologous Groups of proteins (COG), Enzyme Commission number (EC number) database, GenProtEC, EcoCyc, MIPS: MYGD, MIPS: MATD, PEDANT, Proteome.com: YDP and WormPD, MGI: Mouse Genome Database (MGD), TIGR: Microbial databases TIGR: Expressed Gene Anatomy Database, EGAD, Gene Ontology, Institute Pasteur SubtiList, Institute Pasteur TubercuList, Sanger Centre and any combination thereof.
31. The method according to any one of claims 1 to 27, additionally comprising steps of calculating structural similarity by a measure selected from the group consisting of: root mean square deviation (RMSD), exponent of minus squared dissimilarity divided by squared standard deviation, variance measure, probability distribution function, secondary structure assignment, native contact maps, residue interaction patterns, measures of side chain packing, measures of hydrogen bonds retention, dihedral angles of the protein backbones, minRMS, secondary structure elements (SSEs), TM-score, TM-align, protein 3D structure alignment, Residue physic-chemical properties and any combination thereof.
32. The method according to any one of claims 1 to 27, additionally comprising steps of calculating similarity of protein sequences by parameters selected from the group consisting of number of mismatches, hamming distance, position of mismatches relative to the subsequence, sequence complexity, number of repeating amino acids, existence of indels, position specific scoring matrix, hidden Markov Model, Markov Random Field, amino acid properties, similarity to corresponding genetic DNA sequences and any combination thereof.
33. The method according to claim 32, additionally comprising steps of selecting said amino acid properties from the group consisting of size, polarity, hydrophobicity, charge, H-bonding and any combination thereof.
34. The method according to any one of claims 1 to 27, additionally comprising steps of calculating protein sequence similarity by a measure selected from the group consisting of: hamming distance, sequence alignment, BLAST, FASTA, SSEARCH, GGSEARCH, GLSEARCH, FASTM/S/F, NCBI BLAST, WU-BLAST, PSI-BLAST and any combination thereof.

1. A method for annotating a protein sequence or a subsequence thereof, comprising steps of:
a. providing an input protein sequence or a subsequence thereof;
b. defining said subsequence as a central node of a graph or protein network;
c. calculating a subgraph of said graph comprising said central node, according to a predefined radius;
d. calculating weights and/or resistances of edges of said subgraph;
e. identifying annotated nodes in said subgraph;
f. calculating resistance values between said central nodes and each of said annotated nodes in said sub graph; and
g. outputting a list of annotated nodes, wherein each of said annotated nodes is characterized by said calculated resistance value to said central node of said input protein sequence.

2. A method according to claim 1 for annotating a protein sequence or a subsequence thereof, further comprising the step of dividing said protein sequence or a part thereof into subsequences of less than about 25 amino acids and defining each of said subsequences as a central node of a graph or protein network.

3. A method according to claim 1 for annotating a protein sequence or a subsequence thereof, wherein said protein sequence or subsequence is comprised of less than 25 amino acids.

4. A method according to claim 1 for annotating a protein sequence or a subsequence thereof, comprising the further step of adding at least one fake edges to at least one of said sub graphs.

5. A method for characterizing functional and/or structural modules of a protein, comprising steps of:
a. providing an input protein sequence or a part thereof;
b. dividing said input protein into subsequences, each of said subsequences is corresponding to a position of said input protein;
c. defining each of said subsequences as a central node of a graph;
d. for each of said central nodes, extracting or calculating a subgraph of said graph according to a predefined radius;
e. calculating weights and/or resistances of edges for each of said subgraphs;
f. clustering each of said subgraphs according to said calculated weights and/or resistances, alternatively, selecting nodes with minimal resistance to said central node for each of said subgraphs;
g. for each of said subgraphs corresponding to each of said positions of said input protein, generating a list of protein content of each of the clusters containing each of said central nodes, said protein content list comprising at least one of the following (1) names of proteins containing subsequences or nodes forming each of said clusters, (2) independent annotations of subsequences or nodes of each of said clusters;
h. comparing between the protein content list of clusters containing central nodes corresponding to neighboring or adjacent positions of said input protein;
i. identifying positions in said input protein with similar protein content, according to a predefined threshold;
j. mapping the functional and/or structural modules of said input protein by connecting said positions of similar protein content clusters, thereby defining a functional or structural module of said input protein.

6. The method according to claim 5, further comprises steps of clustering said subgraphs by a unction or algorithm selected from the group consisting of spectral algorithm, Markov algorithm, genetic algorithm, simulating annealing and any other method or approach reviewed in at least one of the following: (1) E. Schaeffer, “Graph clustering,” Computer Science Review, vol. 1, pp. 27-64, 2007, (2) S. Fortunato, “Community detection in graphs,” Physics Reports-Review Section of Physics Letters, vol. 486, pp. 75-174, February 2010], clustering according to calculated distances between the nodes by PAM algorithm, hierarchical clustering, other data clustering algorithms and any combination thereof.

7. The method according to claim 5, further comprises steps of comparing between said protein contents by a calculation method or approach selected from the group consisting of Jaccard index, Jaccard similarity coefficient, finding of the most frequent annotation, mutual information and any combination thereof.

8. The method according to claim 5, further comprises steps of creating a publicly available expandable database of said modules.

9. A method for global characterization of proteins, particularly for protein function annotation, comprising steps of:
a. providing an input protein sequence or a part thereof;
b. dividing said input protein into subsequences;
c. defining each of said subsequences as a central node of a protein graph;
d. for each of said central nodes, extracting or calculating a subgraph of said graph according to a predefined radius;
e. calculating weights and/or resistances of edges connecting the nodes within each of said subgraphs;
f. optionally, adding fake edge(s) to at least one of said subgraphs;
g. identifying and selecting proteins containing more than one node connected to different subgraphs; if such proteins are absent or they are not annotated, identifying similarly annotated proteins in different sub graphs;
h. estimating strength of said connections by calculating resistances between said nodes to said central nodes, wherein the higher resistance value the lower strength of said connections; optionally, defining a threshold for connection strength below which said connection will be regarded as insignificant;
i. outputting a descending list of proteins, generated according to size of homology region between said node and said input protein; and
j. annotating or defining said function of said input protein according to the top proteins of said descending list, alternatively, protein function can be annotated or defined as a list of annotations of modules of the protein, produced as described in claim 3.

10. The method according to claim 9, further comprising calculating said homology region by an algorithm determining for a node size of about 20 amino acids:
a. that if two remote nodes of a selected protein are found to be connected to two different sub graphs derived from remote nodes or subsequences of said input protein, then the homology region is defined as about 40 amino acids; and
b. that if the nodes of the selected protein are found to be connected to two adjacent positions of said input protein, the homology region is defined as having about 21 amino acids.

11. A method for protein sequence alignment comprising steps of:
a. providing two input protein sequences for alignment;
b. dividing said input protein sequences into subsequences;
c. defining each of said subsequences of one of said input protein sequences, as a central node of a graph;
d. for each of said central nodes, extracting or calculating a sub graph of said graph according to a predefined radius;
e. calculating weights and/or resistances of edges for each of said subgraphs;
f. selecting pairs of nodes comprising said central node, and the closest node or subsequence from the second input protein to said central node of each subgraph;
g. generating an alignment map according to said pairs of nodes and according to their corresponding resistances; and
h. optionally, generating a multiple alignment map by repeating steps a to g for one or more additional input protein sequences.

12. A method for associating a set of local patterns or profiles recognition with a protein function, comprising steps of:
a. providing an input protein sequence or a part thereof;
b. dividing said input protein into subsequences;
c. defining each of said subsequences as a central node of a graph;
d. for each of said central nodes, extracting or calculating a subgraph of said graph according to a predefined radius;
e. calculating weights and/or resistances of edges for each of said subgraphs;
f. clustering said subgraphs and/or identifying paths through said subgraphs, according to said calculated weights and/or resistances;
g. calculating patterns and/or profiles according to said clusters and/or paths of step f; and
h. associating said patterns and/or profiles with protein function available from annotated nodes or subsequences of correspondent clusters or paths.

13. The method according to claim 12, wherein steps a to h are used for producing a list of mutational changes corresponding to associated functions.

14. The method according to claim 12, wherein steps a to h are used for identifying correlations between protein mutations.

15. The method according to claim 12, wherein steps f to h are applied to distinct subgraphs.

16. The method according to claim 14, further comprises steps of calculating correlations between mutations of nodes derived from different sub graphs.

17. The method according to claim 16, wherein said method is used for producing a list of mutational changes corresponding to their associated functions.

18. A method for protein interaction prediction comprising steps of:
a. providing an input protein sequence or a part thereof;
b. dividing said input protein into subsequences;
c. defining each of said subsequences as a central node of a graph;
d. for each of said central nodes, extracting or calculating a subgraph of said graph according to a predefined radius;
e. calculating weights and/or resistances of the edges for each of said subgraphs;
f. clustering said sub graphs and/or identifying paths through said subgraphs, according to said calculated weights and/or resistances;
g. correlating between mutations according to said clusters and/or paths of step f; and
h. predicting protein interactions according to the results of step g.

19-35. (canceled)
